(19) United States
(12) Patent Application Publication
(10) Pub. No.: US 2025/0392491 A1
(43) Pub. Date: Dec. 25, 2025

(54) RELIABILITY IN MESH MULTICAST TRANSMISSIONS

(71) Applicant: Silicon Laboratories Inc., Austin, TX (US)

(72) Inventor: Hannu Martti Olavi Mallat, Hyvinkaa (FI)

(21) Appl. No.: 18/751,827

(22) Filed: Jun. 24, 2024

(51) Int. Cl. H04L 12/18; H04L 1/00; H04W 84/18

(52) U.S. Cl. CPC H04L 12/1877; H04L 1/0057; H04L 1/0076; H04L 2001/0093; H04W 84/18

(57) ABSTRACT

In one aspect, a method includes: obtaining, in a distributor device of a mesh network, information to be sent to a plurality of nodes of the mesh network; encoding the information according to an encoding scheme to obtain encoded information; partitioning the encoded information into a plurality of encoded portions; transmitting, from the distributor device, an encoded portion of the plurality of encoded portions to the plurality of nodes; re-transmitting the encoded portion to at least one node of the plurality of nodes when the at least one node did not successfully receive the encoded portion; and iteratively transmitting additional encoded portions of the plurality of encoded portions to provide the information to the plurality of nodes.

### BACKGROUND

Many homes, buildings and other locations are provided with multiple wireless networks to enable devices to communicate both with each other and remotely. One common type of network is a wireless mesh network which provides for a personal area network (PAN) or other short-range wireless network to allow devices in close relation to each other to communicate.

For example, different Internet of Things (IoT) or other wireless devices may communicate in a wireless mesh network in accordance with a given Bluetooth specification such as a Bluetooth low energy (BLE) specification. One recent feature in such networks is the ability to provide a firmware update to devices present in a mesh network.

While these networks are suitable for low bandwidth, short communications such as providing control and sensor information, larger communications such as a firmware update can be very difficult to realize within such networks. This is so, since BLE transmissions are subject to bit errors because of the nature of wireless communications, where multiple transmitters may be transmitting at the same time, which may introduce errors for the reception of a particular message.

### SUMMARY OF INVENTION

In one aspect, a method includes: obtaining, in a distributor device of a mesh network, information to be sent to a plurality of nodes of the mesh network; encoding the information according to an encoding scheme to obtain encoded information; partitioning the encoded information into a plurality of encoded portions; transmitting, from the distributor device, an encoded portion of the plurality of encoded portions to the plurality of nodes; re-transmitting the encoded portion to at least one node of the plurality of nodes when the at least one node did not successfully receive the encoded portion; and iteratively transmitting additional encoded portions of the plurality of encoded portions to provide the information to the plurality of nodes.

In one implementation, the method further comprises determining to encode the information when an amount of the information exceeds a threshold. The method also may include: receiving at least one message from the plurality of nodes; and determining whether the plurality of nodes successfully received the encoded portion based at least in part on the at least one message.

In one implementation, the method further comprises transmitting the encoded portion of the plurality of encoded portions to the plurality of nodes via a multicast transmission to a predetermined destination address, the predetermined destination address to indicate that the information is encoded. The method may further comprise negotiating with the plurality of nodes regarding the encoding scheme. The negotiating may include sending, from the distributor device, to one or more of the plurality of nodes a vendor-specific message to indicate that the information is encoded according to the encoding scheme.

In one implementation, each of the plurality of encoded portions comprises a block, the block comprising a plurality of chunks, each of the plurality of chunks comprising a plurality of segments. Encoding the information may further comprise padding a last segment of the plurality of segments of a first chunk of a first block. The information may include a firmware update for the plurality of nodes, and encoding the information comprises encoding the information using a Reed-Solomon encoding to enable erasure correction of up to a predetermined number of segments of a chunk of the plurality of chunks.

In another aspect, an apparatus includes: a radio frequency (RF) transceiver to receive and transmit RF signals in a mesh network; and a baseband processor coupled to the RF transceiver. The baseband processor may include circuitry to: obtain information to be sent to a plurality of nodes of the mesh network; encode the information according to an encoding scheme to obtain encoded information; partition the encoded information into a plurality of blocks, each of the plurality of blocks having a plurality of chunks, each of the plurality of chunks having a plurality of segments; and transmit, via the RF transceiver, the encoded information on a block basis, and retransmit the encoded information of one or more of the plurality of chunks, on the block basis, for any block of the plurality of blocks that was not successfully received by one or more of the plurality of nodes.

In one implementation, the circuitry comprises an encoder to encode the information according to a Reed-Solomon encoding scheme having a (n, k) encoding, where n is a number of output octets of the encoder and k is a number of input octets the encoder, the circuitry to determine n and k based at least in part on a size of the information, wherein each of the plurality of segments is formed of a predetermined number of octets. The circuitry may transmit each of the output octets output by the encoder as a segmented message, the segmented message comprising encoded information of the output segment and a header. The circuitry is to transmit via the RF transceiver the segmented message to the plurality of nodes via a multicast transmission to a predetermined destination address, the predetermined destination address to indicate that the information is encoded. The circuitry may retransmit the segmented message.

In one implementation, the circuitry is to: query one or more nodes of the plurality of nodes to determine whether the one or more nodes support the encoding scheme; and in response to an indication from a first node of the one or more nodes that the first node does not support the encoding scheme, transmit via the RF transceiver the information in an unencoded state.

In an example, the apparatus comprises a distributor device to transmit the information comprising a firmware update. The distributor device is to receive the firmware update from an initiator and a list of devices to be provided with the firmware update, the list of devices comprising the plurality of nodes.

In yet another aspect, an Internet of Things (IoT) device includes: a RF transceiver to receive and transmit RF signals in a mesh network; and a baseband processor coupled to the RF transceiver. The baseband processor may include circuitry to: receive, from a distributor coupled to IoT device via the mesh network, a plurality of chunks of a block of a firmware update, each of the plurality of chunks comprising a plurality of segments, the plurality of chunks comprising encoded information encoded according to an encoding scheme; provide at least a portion of the plurality of chunks and information regarding one or more missing segments within a chunk of the plurality of chunks to a decoder; in the decoder, recover the one or more missing segments based on the encoding scheme, and decode at least the portion of the plurality of chunks; inform the distributor whether the plurality of chunks were successfully decoded; and provide the decoded plurality of chunks to an application.

In one implementation, the IoT device is to receive the plurality of chunks via a multicast transmission to a predetermined destination address, the predetermined destination address to indicate that the firmware update is encoded according to the encoding scheme. The circuitry may provide the plurality of chunks to the decoder when a threshold number of segments of the plurality of chunks has been received. The decoder may receive at least the threshold number of segments and recover at least one segment of the one or more missing segments from at least the threshold number of segments based on the encoding scheme.

### BRIEF DESCRIPTION OF THE DRAWINGS

FIG. 1 is a flow diagram of a method in accordance with an embodiment.

FIG. 2 is a flow diagram of a method in accordance with another embodiment.

FIG. 3 is a flow diagram of a method in accordance with yet another embodiment.

FIG. 4 is a timing diagram illustrating a data communication in accordance with an embodiment.

FIG. 5 is a block diagram of a representative integrated circuit in accordance with an embodiment.

FIG. 6 is a high level diagram of a network in accordance with an embodiment.

### DETAILED DESCRIPTION

In various embodiments, a wireless mesh network may be configured to enable encoded communications to occur in certain instances. For example, for large data transfers such as for a firmware update, blocks of the firmware update image can be encoded with error correction coding and sent to recipients, e.g., using a multicast technique so that this update can be efficiently sent to multiple recipients. This encoding provides error correction capabilities, even in cases where one or more segmented portions of a given block is not received by a receiver. Thus by providing encoded communications, a receiver can potentially recover missing portions of these block-based communications, thus potentially avoiding the need for retransmission, reducing both data transfers and power consumption.

While different encoding techniques can be used, in one or more embodiments a forward error correction (FEC) coding may be used. As a particular example, an erasure code, which is a type of FEC coding, may be used. An erasure code is a type of FEC code that can fix transmission errors that result from erasures, that is, failing to receive data at some locations (as opposed to receiving erroneous data). A receiver that can make use of an erasure code will need to be able to tell the decoder it uses to fix the message at the locations in the message where data was not received.

One erasure encoding is Reed-Solomon (RS) encoding (which is not only an erasure code, but also an error correction code that can fix erroneous as well as missing data). An RS(n, k) encoder takes a block of k symbols (such as binary octets) as input and produces a block of n symbols as output. The corresponding decoder takes the block of n symbols as input and produce a block of k symbols as output, while being able to correct up to (n−k) erased symbols. The overhead of such a code is the fact that n symbols have to be sent to transmit k symbols of payload, but by choosing n and k in a suitable manner, an application can benefit from successfully receiving messages that, without encoding, would have needed to be discarded by the receiver and resent completely by the transmitter.

In a typical RS arrangement, the encoded message is a concatenation of all the k unencoded data symbols without alteration, followed by (n−k) encoded symbols that carry the FEC information. While not specified to be used for error detection per se, a cryptographic network layer message integrity code (MIC) present in protocol data units (PDUs) not only authenticates the PDU payload, which is encrypted using Advanced Encryption Standard counter with cipher block chaining (AES-CCM) by the transmitter, but can also be used to detect bit errors that may have filtered through at a link layer of the receiver. If the receiver cannot authenticate a network PDU with the MIC it contains (whether due to bit errors or a cryptographic problem), it is dropped and not delivered to higher layers in the protocol.

In a Bluetooth Mesh network, nodes transmit messages as broadcast advertisements that may or may not be picked up by the receivers. Message delivery over broadcast advertisements is inherently unreliable, given the nature of wireless transmissions and the fact that there is no coordination between the sender and the receivers, nor between multiple senders. Messages may fail to be delivered, for instance, because multiple senders' transmissions collide and garble each other.

To improve message delivery reliability, two schemes are defined in the protocol stack. First, simple retransmissions (on various layers of the protocol stack) can occur, where sending the same message multiple times increases the chances that at least one attempt is successful. However, when congestion of the shared medium increases to an unmanageable level, increasing the number of retransmissions can adversely affect performance. Second, received transmissions can be acknowledged, followed by retransmissions of unacknowledged messages, or parts thereof on the lower transport layer of the protocol stack. However, this approach is only used in unicast (one to one) messaging.

In many cases, to transmit all but the shortest payloads, payloads can be segmented and reassembled at the lower transport layer. A long message at the sender is cut to segments that can each be fit inside single network layer PDUs. These PDUs are transmitted one by one, and at the receiver the payload is extracted from the segments and reassembled back into a long message. Each segment carries information in its headers identifying the message the segment is part of, as well as its position in the message. Each segment carries 12 octets of payload data, and up to 32 segments can be combined for a maximum of 384 octets of data.

The Bluetooth mesh firmware update feature (introduced in the Bluetooth Mesh specification v1.1) defines an application protocol that uses the Bluetooth Mesh protocol stack. To update firmware of multiple devices in a mesh network, a firmware distributor multicasts the new firmware image data over the mesh network to all updating nodes in the network that can make use of the same firmware image. This firmware update feature defines an application protocol scheme where a firmware image is transmitted over the mesh network in fragments called chunks. Each chunk is transmitted as an individual segmented message. The transmission of a multicast message containing a chunk can be a single transmission, or it can be a number of simple repetitions in quick succession.

A consecutive predetermined number of chunks forms a block. When all chunks of a block have been multicast once, the distributor requests all updating nodes to provide feedback information as to which chunks of that block they received successfully. Based on the feedback information, the distributor determines chunks that at least one updating node missed, and retransmits such chunks. This process continues until all nodes have received all chunks in that block. Then, the distributor moves to the next block, and so on, until the whole of the firmware image data is distributed.

This multicast acknowledgement scheme at the application (firmware upgrade) specification is done on a per a segmented message (i.e., chunk), and not per segment. As such, without an embodiment the loss of a single segment invalidates an entire chunk at the receiver, and causes a retransmission of the full chunk. With a large number of nodes in a network, the number of chunks that at least one node missed due to some interference can be relatively large, and thus without an embodiment, a large number of retransmissions may be incurred to deliver all chunks of a block to all nodes.

Accordingly, when a given amount of data to be sent is relatively large, such as for a firmware upgrade, data may be encoded using an erasure code encoder before transmission. With such an arrangement the receiver can, up to a point, correct reception errors and receive data with a much higher probability than it would without the encoding, reducing retransmissions.

Embodiments may be particularly suitable for multicasts, which lack explicit receiver acknowledgement in the mesh protocol stack, but can be used for unicast messaging as well. While unicast segmented messaging makes use of explicit acknowledgement of received segments, it can still be useful to reduce the need to retransmit lost segments.

For purposes of encoding and decoding considerations, it can be assumed that: every received bit can be considered correct with extremely high likelihood; transmission errors that do occur are losses of a complete segment (meaning that if data is lost, it is lost 12 octets at a time); if at least one segment of a message is received, it can be determined from lower transport layer header information which segments have been received (or not); and thus an erasure decoder can be provided an exact map of erasure locations. The only caveat to this is that a final segment might be less than the full 12 octets, but this will be discussed in detail later.

Since a RS(n, k) code can handle erasure of t=(n−k) symbols (symbols being binary octets in this case), encoder parameters can be chosen so that t=12 to handle a full segment loss and reconstruction. Likewise, k is a multiple of 12 to facilitate encoding of full segments.

As an example, the following RS codes could be used:
RS(252,192)—encode 16 segments (192 octets) into 21 segments (252 octets), providing erasure correction of 5 segments
RS(252, 240)—encode 20 segments (240 octets) into 21 segments (252 octets), providing erasure correction of 1 segment

Of course, any other suitable parametrization can be used, depending on the expected error rate of the environment, as well as the typical length of data that is transmitted.

In embodiments, a receiver is configured to distinguish whether regular or encoded segmented messaging is used at the lower transport layer. Since there are no unused (RFU) bits in the lower transport layer header for segmented data messages, nor in the network layer PDU header, a PDU cannot be marked to indicate support for this scheme directly.

Instead, a different encoding indication can be configured. For example, the sender and the receiver can participate in a negotiation to agree that one or more of a particular encryption key, a particular source address, or a particular destination address is only used for encoded segmented message transmission.

In an embodiment, devices in a mesh network can be configured (e.g., via firmware) to support one or more encodings. And a predetermined address, e.g., a virtual address can be assigned for each RS encoding. This virtual address is a special type of multicast address that is 128 bits in length and freely assignable by a manufacturer for a given purpose. Thus in this case, a distributor uses the virtual address as the destination for segments that are encoded with a particular RS encoder and the receiver can determine based on the address which decoding to use.

Note that the virtual address usage can be recognized directly at the receiver transport layer such that the encoding techniques described herein can be used for any application protocol, and not just for firmware updates. In other cases, one or more negotiation messages in the Device Firmware Update protocol can be used for a handshake. For example, a “Firmware Update Firmware Metadata Check” message can be sent to check if updating nodes can accept an update; and it includes a vendor specific metadata parameter that can advertise the encoding scheme. Then the updating nodes can respond by sending a “Firmware Update Firmware Metadata Status” giving an ok/not ok after verifying.

Note that any network layer relays on the path from sender to receiver do not need to be aware of the arrangement, as relayed network PDUs are not reassembled at relays.

As mentioned above, the last segment that carries data for a message may or may not be a full 12 octet segment, depending on the length of the message being transmitted. To facilitate easy erasure position determination, the sender can send all segments as full 12 octet segments. This means that if the last data segment would have less than 12 octets of meaningful payload, it is padded with dummy data on transmission.

On reception, the dummy data is stripped out. In an embodiment, this can be achieved by the following arrangement: a segment that has one octet of padding at the end will have the last octet's value set to 0×01; a segment that has two octets of padding at the end will have the two last octets' values set to 0×02 0×02; a segment that has three octets of padding at the end will have the three last octets' values set to 0×03 0×03 0×03; and etc. Note that a segment having 11 octets of padding at the end will have the 11 last octets' values set to 0×0b 0×0b 0×0b 0×0b 0×0b 0×0b 0×0b 0×0b 0×0b 0×0b 0×0b.

A receiver, on detection of one of these patterns in the last segment carrying payload data, is configured to: strip out the assumed padding and try to decrypt the payload (which contains a MIC for authentication). If successful, the padding was correctly detected and the payload data has now been correctly decrypted. If decryption is not successful, padding detection was a false positive. The receiver then tries to decrypt the payload with all data present in the last segment; if successful, payload data was actually not padded, but is now correctly decrypted. Otherwise, the message is discarded as erroneous.

With one padding octet there is a 1/256 chance of a false positive, but this is easily detected by authentication failure at AES-CCM decryption, and the cost of the additional decryption attempt is not meaningful at this rate. The additional false positives for multi-octet padding are even more unlikely ( 1/65536 for two-octet padding, etc.).

In one implementation, a transmitter, for a given segmented message, can determine (e.g., using a higher layer application) whether to use regular or encoded messaging. When it is determined to perform encoding, an encoded payload is calculated based on the payload. The payload is then segmented into individual partitions or blocks, which in turn are formed of multiple groups or chunks, in turn formed of multiple segments (where each segment may be an octet). Each block is transmitted, including any retransmission and acknowledgement handling as needed. For encoded messaging, the agreed upon mechanism for indicating the encoded messaging is used (e.g., send to the pre-defined destination address).

At the receiving device, an implementation making use of this feature would work roughly as follows. The receiver receives the segments that are currently possible to receive. If regular messaging is detected, until all segments are received or reception times out the following occurs: for a unicast message, an acknowledge is sent to the sender to identify which segments were received and wait for more segments; for a multicast message, more segments are waited for.

If an encoded messaging is detected, until enough segments are received or reception times out, the following occurs: for a unicast message, an acknowledge is sent to the sender to identify which segments were received and wait for more segments; for a multicast message, more segments are waited for. Note that what is enough segments to move forward with depends on the chosen encoder parameters.

If regular messaging is used, segment payloads are reassembled to form the complete message payload. If encoded messaging is used, the received segments and the information on erasures (segments not received) are provided to the decoder, which computes the decoded message payload, and then passes the message payload to the higher layer processing.

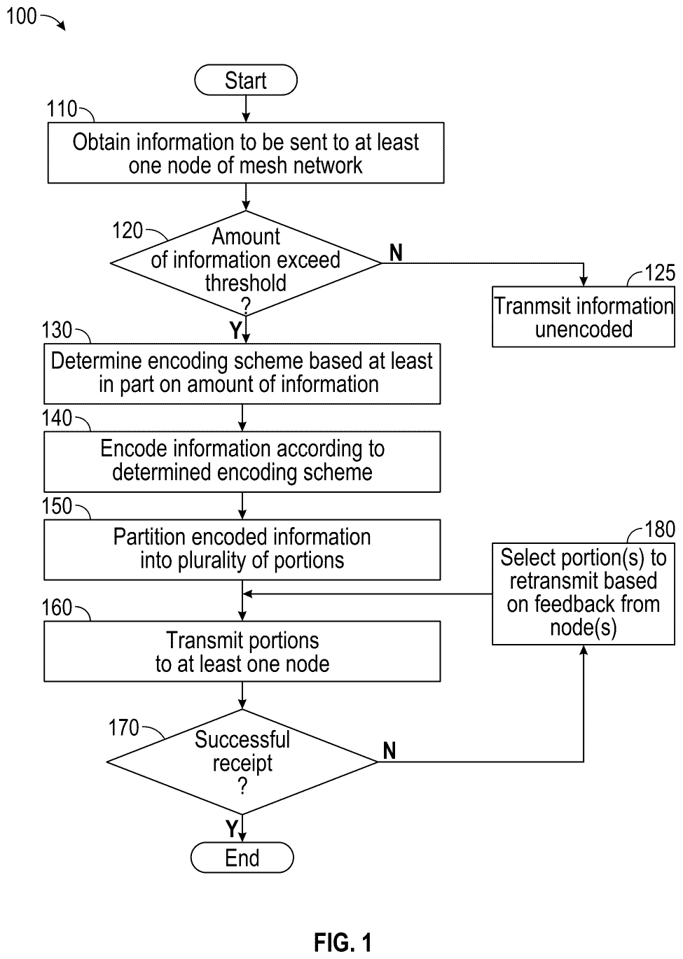

Referring now to FIG. 1, shown is a flow diagram of a method in accordance with an embodiment. In FIG. 1, method 100 is performed by circuitry of a transmitter in determining and handling transmission of an encoded message. As such, method 100 may be performed by hardware circuitry of the transmitter alone and/or in combination with firmware and/or software. As illustrated, method 100 begins by obtaining information to be sent to at least one node of a mesh network (block 110). Assume for purposes of discussion that this information is a firmware update that the transmitter receives from an initiator, e.g., in the form of an updated firmware image.

Still referring to FIG. 1, next at diamond 120, it is determined whether the amount of information to be sent exceeds a threshold. If not, control passes to block 125 where the information can be sent without performing any encoding.

When it is determined that the amount information exceeds the threshold, at block 130, an encoding scheme is determined. In an embodiment, this determination may be based at least in part on the amount of information, and may also be based on an expected PDU loss probability. In this way, in a more difficult environment, and encoding with greater redundancy may be selected. Assume for purposes of discussion that the encoding scheme is a given RS encoding. Next at block 140, the information is encoded according to the determined encoding scheme. At block 150, the encoded information is partitioned into a plurality of portions or blocks. Note that these portions or blocks may be further subdivided into a set of smaller groupings of chunks, and the chunks, in turn, can be formed of smaller portions, e.g., the segments described herein.

At block 160, the portions may be transmitted to at least one node. Note that at diamond 170 it is determined whether the portions are successfully received. If so, the transmission concludes. Otherwise, at block 180, based on feedback information from the nodes, e.g., in the form of acknowledgements that indicate which portions were received and which were not, selected portions of the encoded information can be retransmitted, with control passing back to block 160. Although shown at this high level in the embodiment of FIG. 1, understand that many variations and alternatives are possible. For example, note that while FIG. 1 is in the context of transmitting all portions and then determining whether receipt is successful, in particular embodiments, information at a block level can be sent and acknowledged and any retransmissions necessary sent, before moving to a next block.

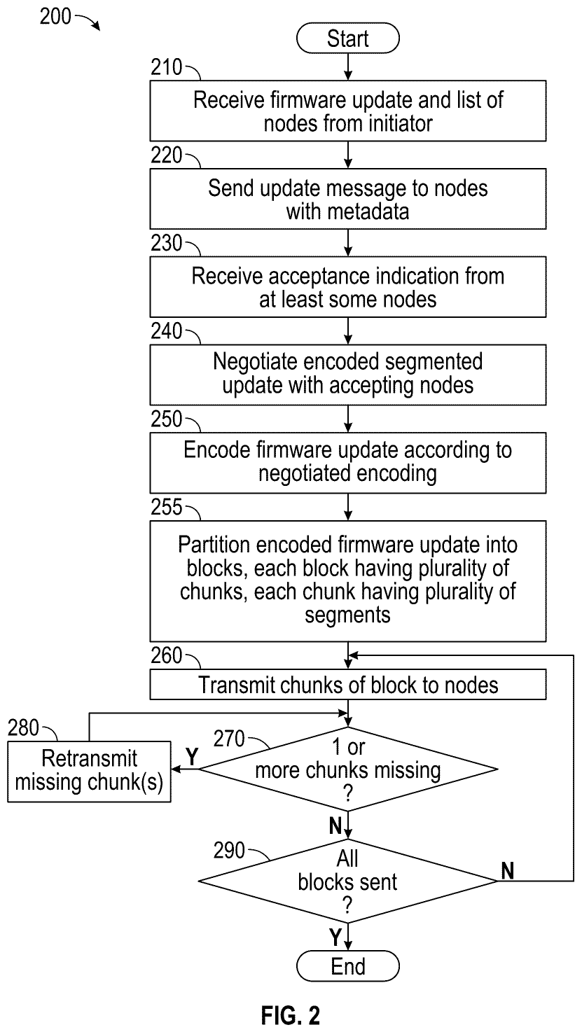

Referring now to FIG. 2, shown is a flow diagram of a method in accordance with another embodiment. More specifically, method 200 is another implementation of a firmware update process in accordance with an embodiment. As shown in FIG. 2, method 200 may be performed by hardware circuitry of the transmitter alone and/or in combination with firmware and/or software.

As illustrated, method 200 begins at block 210 by receiving a firmware update and a list of nodes to which the firmware update is to be sent. This information is received from an initiator, in the distributor. In an embodiment, the distributor has the firmware binary and the list of updating nodes (devices that will receive the update). The list of updating nodes can be a list of mesh unicast addresses, one per device Next at block 220, an update message is sent to the identified nodes along with metadata, which describes the characteristics of the firmware update. Thus the distributor queries the updating nodes to determine whether they are ready to receive an update and their capabilities (which may describe how large data an updating node can receive in total, how large firmware image blocks it can handle, and how large chunks it can handle). In response, understand that the nodes send back an indication of acceptance, which is received from at least some of the nodes at block 230. Thereafter, a negotiation process can be performed with these accepting nodes to negotiate the parameters of an encoded segmented update (block 240).

Still referring to FIG. 2, based at least in part on this negotiation, the firmware update may be encoded (block 250). Then, at block 255, the distributor can partition the encoded firmware update into blocks. In this particular embodiment, understand that these blocks may be formed of a plurality of chunks, where each of the plurality of chunks is formed of a number of segments (and where the segments each may include an octet of information). For example, assume that there is a 512 kB image to transfer, and updating nodes can handle 8 kB blocks. Then there are 64 blocks to send, where each block is split into chunks in a way that a single chunk can be sent in a single (segmented) message. Assume each chunk is 128 bytes of payload; then an 8 kB block splits into 64 chunks. In turn, each 128 byte chunk includes 11 segments (where a single mesh transport layer segment can carry 12 bytes of payload and the protocol payload is small so 11 segments is enough). Thus in this example, in total there are 11×64×64 segments to send at minimum, and in practice much more due to packet loss. In an embodiment, the transport layer is configured to: repeat each segmented message a given number of times (e.g., between 1 and 8 times), pause between every message repetition for a given amount of time, and pause between every segment for a given amount of time.

With further reference to FIG. 2, control next passes to block 260 where the chunks of a given block are transmitted to the nodes. That transmission may be a Bluetooth mesh binary large object (BLOB) transfer, and in some cases each of the segments of a given chunk can be sent possibly multiple times to better ensure reception.

Then the distributor determines at diamond 270, whether one or more chunks are identified as missing from at least one of the nodes. As discussed above, this may be based on acknowledgment messages sent from the nodes. If such chunks are missing, they may be retransmitted at block 280 (in either multicast or unicast form). When it is determined that all chunks are successfully received for a given block, control passes to diamond 290 to determine whether all blocks have been sent. If not, control passes back to block 260 for transmission of the chunks of a next block. Otherwise, the firmware update successfully concludes. Of course, additional operations are possible. For example, once all blocks have been transferred, a higher layer protocol or application can decide what to do next; in case of firmware update, the distributor may request that the updating nodes apply the update. Understand that many variations and alternatives are possible.

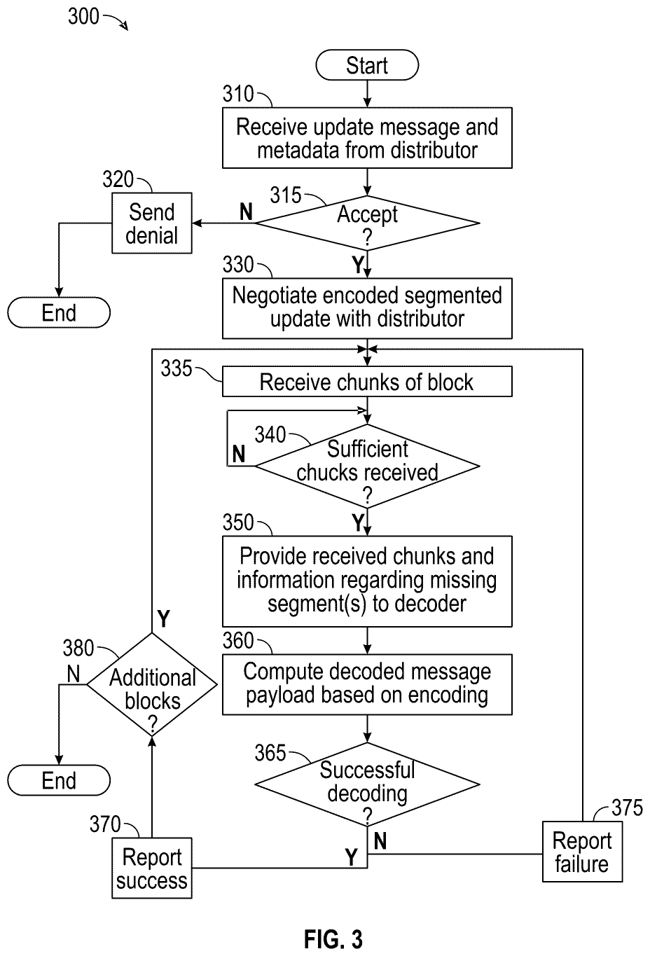

Referring now to FIG. 3, shown is a flow diagram of a method in accordance with yet another embodiment. More specifically, FIG. 3 is a method for handling receipt of an encoded message in a receiver. As such, method 300 may be performed by hardware circuitry of the receiver alone and/or in combination with firmware and/or software.

Method 300 begins by receiving an update message and metadata from a distributor (block 310). The receiver may determine to accept the message (diamond 315), e.g., based upon its capacity including sufficient power levels, storage and so forth. If the receiver is not available to handle the firmware update, control passes to block 320 where a denial is sent back to the distributor.

Otherwise, when it is determined that the receiver is capable of accepting the firmware update, control passes to block 330, where an encoded segmented update may be negotiated with the distributor. Thus, at this point the receiver is ready to start receiving the update, which it receives on a block basis, starting at block 335, where it receives chunks of a given block as a plurality of segmented messages. In an embodiment, the transport layer of the receiver is configured to discard partially received messages after a given idle time has elapsed, to ensure that partially received messages do not consume resources forever.

It is next determined whether a sufficient number of chunks is received (at diamond 340). Note that this determination may be based in part on a given encoding scheme. More specifically, this determination as to whether a sufficient number of segments has been received considers whether the received segments can be used to reconstruct missing payload segments. This determination may be a numeric comparison, as the maximum number of segments that can be missed and the number of segments received are known.

When it is determined that the sufficient number of chunks has been received, they are provided to a decoder or receiver, along with information regarding any missing segments within the chunks. Then at block 360, the decoder may compute a decoded message payload based on the encoding and the received chunks. It is determined at diamond 365 whether decoding was successful. If not, control passes back to block 375, where a failure report may be sent back to the distributor. Eventually this will cause the distributor to resend the chunks of that block, and control again proceeds from block 335. Otherwise, when it is determined that the coding was successful, control passes to block 370, where a successful receipt is reported. If additional blocks are to be received, as determined at diamond 380, control passes again back to block 335. Otherwise, a successful firmware update has occurred and method 300 concludes. Although shown at this high level in the embodiment of FIG. 3, many variations and alternatives are possible.

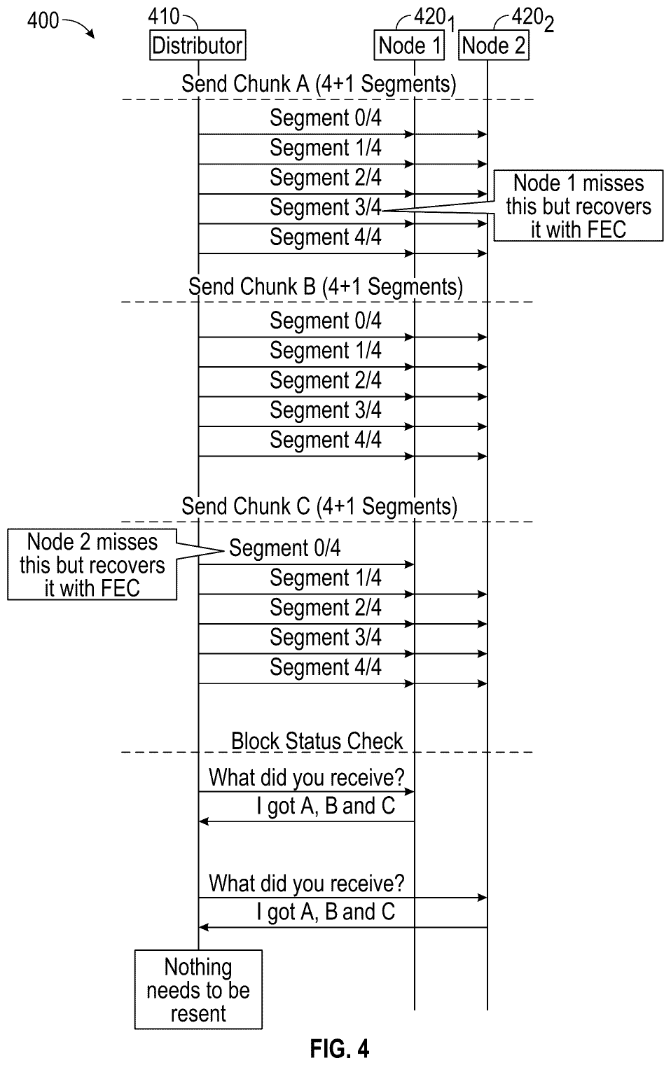

Referring now to FIG. 4, shown is a timing diagram of transmission of a multicast data communication in accordance with an embodiment. As shown in FIG. 4, in an environment 400 a distributor 410 and receiving nodes 420_{1, 2} are present. More specifically FIG. 4 shows communication of a block, e.g., of a larger communication, in turn formed of multiple chunks each having multiple encoded segments. In the embodiment shown, for each four segments of payload information (e.g., 48 bytes), an additional segment (e.g., 12 bytes) of encoding information is included.

Distributor 410 sends consecutively given segments of each chunk; although only a single transmission per segment is shown, understand that in some cases repeated transmissions of each segment may occur (which may be dependent on configuration, such as based on size of the mesh network, number of receiving nodes or so forth).

When distributor 410 completes sending all of these segments of all included chunks of a block, it may issue a block status check request to the nodes to confirm which blocks were successfully received. Note that the response from the nodes here is a successful acknowledgment, and thus none of the chunks of the block need to be re-transmitted following the status check. This is the case since as shown in FIG. 4, although each node 420 misses at least one segment, by way of the encoding scheme used, the nodes can recover the missing segments, avoiding the need for additional full re-transmission of any of the chunks. Note that while in FIG. 4, a high level example is shown with 5 segments per chunk and 3 chunks form a block, as described above many different block, chunk and segment sizes are possible.

To demonstrate the efficiency of encoding in accordance with an embodiment, consider the following example scenario of an unencoded transmission:
There are 100 updating nodes that need to receive a multicast firmware update. Firmware update chunks are sent using 16-segment messages
The probability to lose a segment to transmission errors is p=0.10 (10%)

Then,
The probability to receive a full chunk correctly in a single transmission is (1−p)\hat{ }16=18.5%, meaning that on the average 87/100 nodes do not receive the chunk without transmitter repetition.
Repeating the message increases probability to receive at the expense of extra load on the network.
With, for example, four transmissions the probability to get a single segment through is much better at 99.8%, since the loss probability is now minuscule 0.10\hat{ }4, but note that this uses four times more network bandwidth than a single transmission.
Even with that amount of repetition, chunk delivery probability to all 100 nodes is not perfect, being (0.998\hat{ }100)=85.2%, and a block typically includes more than one chunk, thus repeated transmissions are very much needed for distributing the firmware updates successfully.

Now consider that for an example RS(252,192) encoding in an embodiment. This means a chunk will be delivered if either
No errors occur, or
A single segment—any one of the 16—is lost, or two segments—any two of the 16—are lost, or three segments—any three of the 16—are lost, or four segments—any four of the 16—are lost, or five segments—any five of the 16 are lost

There is thus a 98.6% delivery chance, instead of just 18.5%, for delivering a single message to a single node using a single transmission. With one backup transmission, the chance would be lifted to close to 100% to a single node, and delivery to 100 nodes would work with 99.9% probability.

Thus, with RS encoding, 262.5% of the payload can be sent (that is, 31.25% overhead for encoding for each transmission, and two transmissions), to achieve a substantially higher message delivery probability, instead of having to send 400% of the payload (that is, 100% overhead for each extra transmission) for worse delivery results.

Embodiments thus use an encoding scheme (e.g., Reed-Solomon encoding) for increasing reliability of Bluetooth mesh segmented messaging, especially in the context of multicast segmented messaging as used in mesh device firmware updates. The encoding allows for restoration of lost segment data, which reduces the need for retransmissions that put load on the network, at a relatively modest overhead on the sent data resulting from the sending of FEC information together with the data.

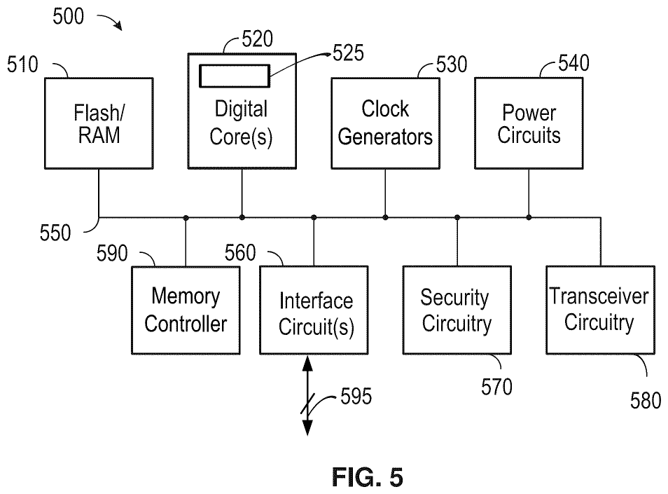

Referring now to FIG. 5, shown is a block diagram of a representative integrated circuit 500 that may be implemented in any type of wireless device, as described herein. In the embodiment shown in FIG. 5, integrated circuit 500 may be, e.g., a dual mode wireless transceiver that may operate according to one or more wireless protocols (e.g., WLAN and Bluetooth, among others) or other device that can be used in a variety of use cases. In one or more embodiments, the circuitry of integrated circuit 500 shown in FIG. 5 may be implemented on a single semiconductor die.

Integrated circuit 500 may be included in a range of devices including a variety of stations, including smartphones, wearables, smart home devices, IoT devices, vehicle devices, other consumer devices, or industrial, scientific, and medical (ISM) devices, among others.

In the embodiment shown, integrated circuit 500 includes a memory system 510 which in an embodiment may include volatile storage, such as RAM and non-volatile memory such as a flash memory. The flash memory is a non-transitory storage medium that can store instructions and data. In embodiments, this storage may store code to perform encoding and decoding of firmware update and other large data transfers as described herein, as well as to store the firmware itself. As further shown integrated circuit 500 also may include a memory controller 590.

Memory system 510 couples via a bus 550 to one or more digital cores 520, which may include one or more cores and/or microcontrollers that act as processing units of the integrated circuit. As illustrated, cores 520 may include coding circuitry 525 that is configured to perform encoding and decoding of large data transfers as described herein. In turn, digital cores 520 may couple to clock generators 530 which may provide one or more phase locked loops or other clock generator circuitry to generate various clocks for use by circuitry of the IC.

As further illustrated, IC 500 further includes power circuitry 540. Additional circuitry may be present depending on particular implementation to provide various functionality and interaction with external devices. Such circuitry may include interface circuitry 560 which provides a digital communication interface with additional circuitry (such as a memory, to couple to IC 500 via a link 595). IC 500 also may include security circuitry 570 to perform wireless security techniques.

In addition, as shown in FIG. 5, transceiver circuitry 580 may be provided to enable transmission and reception of wireless signals, e.g., according to one or more of a local area or wide area wireless communication scheme, such as Zigbee, Bluetooth, IEEE 802.11, IEEE 802.15.4, cellular communication or so forth. Understand while shown with this high level view, many variations and alternatives are possible.

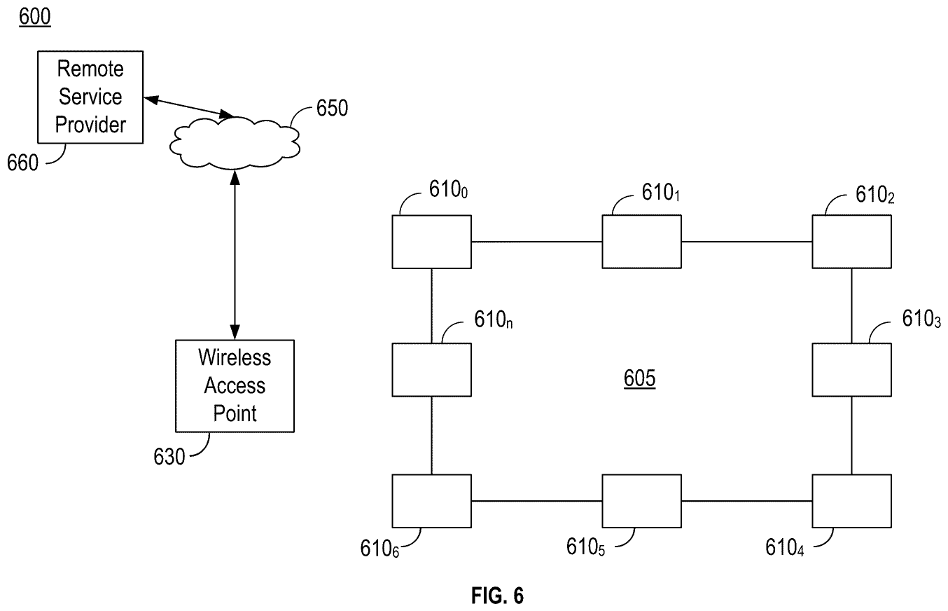

ICs such as described herein may be implemented in a variety of different devices such as wireless stations, IoT devices, vehicle devices or so forth. Referring now to FIG. 6, shown is a high level diagram of a network in accordance with an embodiment. As shown in FIG. 6, a network 600 includes a variety of devices, including wireless stations including smart devices such as IoT devices, access points and remote service providers, which may leverage embodiments for performing encoding and decoding of large message transfers as described herein.

In the embodiment of FIG. 6, a wireless network 605 is present, e.g., in a building having multiple wireless devices 610₀₋ₙ. As shown, wireless devices 610 couple to an access point 630 that in turn communicates with a remote service provider 660 via a wide area network 650, e.g., the internet. Understand while shown at this high level in the embodiment of FIG. 6, many variations and alternatives are possible.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
obtaining, in a distributor device of a mesh network, information to be sent to a plurality of nodes of the mesh network;
encoding the information according to an encoding scheme to obtain encoded information;
partitioning the encoded information into a plurality of encoded portions;
transmitting, from the distributor device, an encoded portion of the plurality of encoded portions to the plurality of nodes;
re-transmitting the encoded portion to at least one node of the plurality of nodes when the at least one node did not successfully receive the encoded portion; and
iteratively transmitting additional encoded portions of the plurality of encoded portions to provide the information to the plurality of nodes.

2. The method of claim 1, further comprising determining to encode the information when an amount of the information exceeds a threshold.

3. The method of claim 1, further comprising:
receiving at least one message from the plurality of nodes; and
determining whether the plurality of nodes successfully received the encoded portion based at least in part on the at least one message.

4. The method of claim 1, further comprising transmitting the encoded portion of the plurality of encoded portions to the plurality of nodes via a multicast transmission to a predetermined destination address, the predetermined destination address to indicate that the information is encoded.

5. The method of claim 1, further comprising negotiating with the plurality of nodes regarding the encoding scheme.

6. The method of claim 5, wherein the negotiating comprises sending, from the distributor device, to one or more of the plurality of nodes a vendor-specific message to indicate that the information is encoded according to the encoding scheme.

7. The method of claim 1, wherein each of the plurality of encoded portions comprises a block, the block comprising a plurality of chunks, each of the plurality of chunks comprising a plurality of segments.

8. The method of claim 7, wherein encoding the information further comprises padding a last segment of the plurality of segments of a first chunk of a first block.

9. The method of claim 7, wherein the information comprises a firmware update for the plurality of nodes, and encoding the information comprises encoding the information using a Reed-Solomon encoding to enable erasure correction of up to a predetermined number of segments of a chunk of the plurality of chunks.

10. An apparatus comprising:
a radio frequency (RF) transceiver to receive and transmit RF signals in a mesh network; and
a baseband processor coupled to the RF transceiver, the baseband processor comprising circuitry to:
obtain information to be sent to a plurality of nodes of the mesh network;
encode the information according to an encoding scheme to obtain encoded information;
partition the encoded information into a plurality of blocks, each of the plurality of blocks having a plurality of chunks, each of the plurality of chunks having a plurality of segments; and
transmit, via the RF transceiver, the encoded information on a block basis, and retransmit the encoded information of one or more of the plurality of chunks, on the block basis, for any block of the plurality of blocks that was not successfully received by one or more of the plurality of nodes.

11. The apparatus of claim 10, wherein the circuitry comprises an encoder to encode the information according to a Reed-Solomon encoding scheme having a (n, k) encoding, wherein n is a number of output octets of the encoder and k is a number of input octets the encoder, the circuitry to determine n and k based at least in part on a size of the information, wherein each of the plurality of segments is formed of a predetermined number of octets.

12. The apparatus of claim 11, wherein the circuitry is to transmit each of the output octets output by the encoder as a segmented message, the segmented message comprising encoded information of the output segment and a header, wherein the circuitry is to transmit via the RF transceiver the segmented message to the plurality of nodes via a multicast transmission to a predetermined destination address, the predetermined destination address to indicate that the information is encoded.

13. The apparatus of claim 12, wherein the circuitry is to retransmit the segmented message.

14. The apparatus of claim 10, wherein the circuitry is to:
query one or more nodes of the plurality of nodes to determine whether the one or more nodes support the encoding scheme; and
in response to an indication from a first node of the one or more nodes that the first node does not support the encoding scheme, transmit via the RF transceiver the information in an unencoded state.

15. The apparatus of claim 10, wherein the apparatus comprises a distributor device to transmit the information comprising a firmware update.

16. The apparatus of claim 15, wherein the distributor device is to receive the firmware update from an initiator and a list of devices to be provided with the firmware update, the list of devices comprising the plurality of nodes.

17. An Internet of Things (IoT) device comprising:
a radio frequency (RF) transceiver to receive and transmit RF signals in a mesh network; and
a baseband processor coupled to the RF transceiver, the baseband processor comprising circuitry to:
receive, from a distributor coupled to IoT device via the mesh network, a plurality of chunks of a block of a firmware update, each of the plurality of chunks comprising a plurality of segments, the plurality of chunks comprising encoded information encoded according to an encoding scheme;
provide at least a portion of the plurality of chunks and information regarding one or more missing segments within a chunk of the plurality of chunks to a decoder;
in the decoder, recover the one or more missing segments based on the encoding scheme, and decode at least the portion of the plurality of chunks;
inform the distributor whether the plurality of chunks were successfully decoded; and
provide the decoded plurality of chunks to an application.

18. The IoT device of claim 17, wherein the IoT device is to receive the plurality of chunks via a multicast transmission to a predetermined destination address, the predetermined destination address to indicate that the firmware update is encoded according to the encoding scheme.

19. The IoT device of claim 17, wherein the circuitry is to provide the plurality of chunks to the decoder when a threshold number of segments of the plurality of chunks has been received.

20. The IoT device of claim 19, wherein the decoder is to receive at least the threshold number of segments and recover at least one segment of the one or more missing segments from at least the threshold number of segments based on the encoding scheme.
